(19) United States
(12) Patent Application Publication
(10) Pub. No.: US 2004/0223820 A1
(43) Pub. Date: Nov. 11, 2004

(54) Drilling device having driving and rotating motor

(76) Inventor: Daive Shieh, Taichung (TW)

Correspondence Address: Daive Shieh, P.O. Box 63-99, Taichung, 406, TW

(21) Appl. No.: 10/434,989

(22) Filed: May 7, 2003

(51) Int. Cl. B23B 45/14

(52) U.S. Cl. 408/76

(57) ABSTRACT

A drilling device includes a barrel slid ably received in a conduit of a housing and movable up and down relative to the conduit of the housing, and a shank rotatably secured in the barrel and movable up and down relative to the conduit of the housing in concert with the barrel. A motor is arranged to rotate the shank and to move the barrel up and down relative to the conduit of the housing simultaneously, to allow the barrel and the shank to be actuated simultaneously by the motor. The housing includes an electromagnetic member for securing onto objects. A control circuit may be used to control the motor.

### BACKGROUND OF THE INVENTION

1. Field of the Invention

The present invention relates to a drilling device, and more particularly to a drilling or tapping machine or device having a single motor for driving and rotating tool members.

2. Description of the Prior Art

Typical drilling devices comprise a drilling tool member rotatably secured in a machine body, and movable up and down relative to the machine body, for drilling purposes. The drilling or tapping machines or devices comprise a huge volume and a heavy weight that may not be moved or carried by the users.

The other typical drilling devices comprise a drilling tool member rotatably secured in a machine body and rotated or driven by a motor, and movable up and down relative to the machine body by another motor, for drilling purposes. The provision and the coupling of the two motors to the drilling tools also greatly increase the volume and the weight of the drilling or tapping machines or devices, such that the other typical drilling or tapping machines or devices also may not be easily moved or carried by the users.

The present invention has arisen to mitigate and/or obviate the afore-described disadvantages of the conventional drilling or tapping devices or machines.

### SUMMARY OF THE INVENTION

The primary objective of the present invention is to provide a drilling or tapping machine or device including a single motor for simultaneously driving or moving and rotating the drilling tool members.

In accordance with one aspect of the invention, there is provided a drilling device comprising a housing including a conduit, a barrel slid ably received in the conduit of the housing, and movable up and down relative to the conduit of the housing, a shank rotatably secured in the barrel and movable up and down relative to the conduit of the housing in concert with the barrel, a motor disposed in the housing, and means for coupling the motor to rotate the shank and to move the barrel up and down relative to the conduit of the housing simultaneously, to allow the barrel and the shank to be actuated simultaneously by the motor.

The motor includes a spindle, and the coupling means includes a first coupling device coupled between the shank and the spindle, to allow the shank to be rotated by the motor. The first coupling device includes a gear coupled to the shank with a key connection, to allow the shank to be moved up and down relative to the gear and to be rotated by the gear.

The coupling means includes a second coupling device coupled between the first coupling device and the barrel, to allow the barrel to be moved up and down relative to the conduit of the housing by the motor. The barrel includes a rack provided thereon, the second coupling device includes a worm engaged with the rack of the barrel, to move the barrel up and down relative to the conduit of the housing when rotating the worm.

The first coupling device includes a rod, a first connecting device coupled between the rod and the motor, the second coupling device includes a gear secured to the worm, a pole having a worm member engaged with the gear of the worm, and a second connecting device coupled between the pole and the rod.

The housing includes a positioning device attached thereto, to secure the housing onto objects. The positioning device may be an electromagnetic member or the like.

A control circuit may further be provided and coupled to the motor, and to control the motor. The control circuit includes a switch member coupled to the motor, in order to switch and control the motor. The control circuit includes an adjusting device to adjust the motor to different rotational speeds.

The control circuit includes a starting circuit coupled to the motor to gradually increase a rotational speed of the motor. The control circuit includes a compensating circuit coupled to the motor, to compensate an electric energy supplied to the motor.

Further objectives and advantages of the present invention will become apparent from a careful reading of the detailed description provided herein below, with appropriate reference to the accompanying drawings.

### BRIEF DESCRIPTION OF THE DRAWINGS

FIG. 1 is a perspective view of a drilling device in accordance with the present invention;

FIG. 2 is a plan view of the drilling device, in which a portion of the drilling device has been cut off to show the inner structure of the drilling device;

FIG. 3 is a partial top schematic view of the drilling device;

FIG. 4 is a partial side schematic view of the drilling device, illustrating one of the transmission or coupling devices of the drilling device; and

FIG. 5 is a schematic view illustrating the electric circuit for the motor of the drilling device.

### DETAILED DESCRIPTION OF THE PREFERRED EMBODIMENT

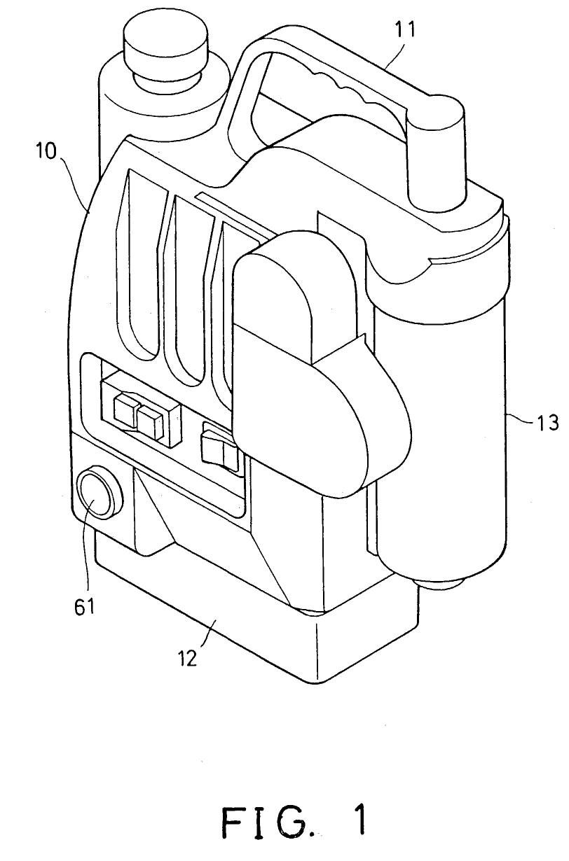

Referring to the drawings, and initially to FIGS. 1-4, a drilling device in accordance with the present invention comprises a housing 10 including a handle member 11 provided thereon for carrying purposes, and for allowing the housing of the drilling device to be easily moved and carried by the users.

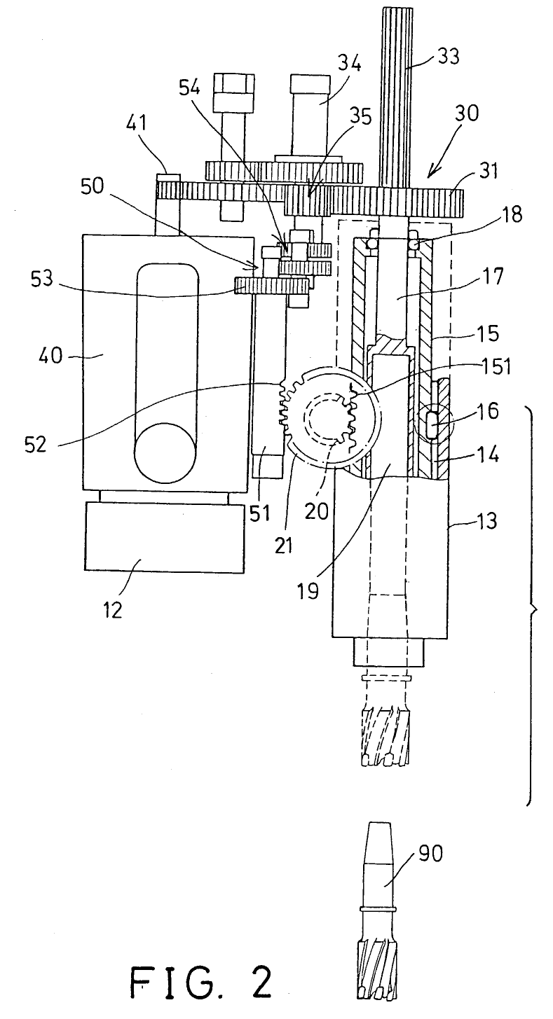

A positioning device 12, such as a vacuum sucker member, a magnetic member, an electromagnetic member 12, is provided or attached to the bottom of the housing 10, for securing or attracting and thus positioning the housing 10 on top of work pieces, work tables, or other objects to be drilled with holes therein. The housing 10 includes a conduit 13 provided on one side thereof, and having one or more guide channels 14 formed therein (FIG. 2).

A barrel 15 includes one or more keys or guide members 16 slid ably engaged in the guide channels 14 of the conduit 13 respectively, in order to guide the barrel 15 to move up and down relative to the conduit 13, and to prevent the barrel 15 from being rotated relative to the conduit 13. The barrel 15 includes a number of teeth or a rack 151 provided on the outer peripheral portion thereof (FIG. 2).

A shank 17 is rotatably secured to or in the barrel 15 with one or more bearings 18, and movable up and down relative to the conduit 13, in concert with the barrel 15. The shank 17 includes a bore 19 formed therein to receive a tool member 90, such as a tapping or drilling tool member 90 therein, such that the tool member 90 may be moved up and down by the barrel 15, and may be rotated in concert with the shank 17.

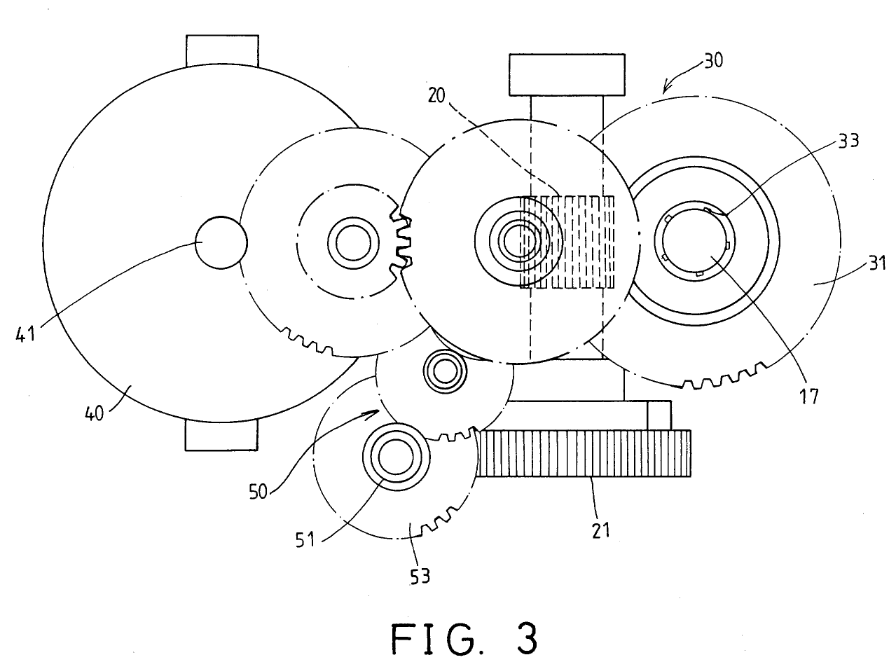

A motor 40 is disposed in the housing 10, and includes a spindle 41 coupled to the shank 17 with a reduction gearing or a transmission or coupling device 30, such as a typical pulley-and-belt coupling device (not shown), a typical sprocket-and-chain coupling device (not shown), or a gearing coupling device 30 as shown in FIGS. 2, 3, in order to rotate or drive the shank 17. The shank 17 is slid ably coupled to a gear 31 of the gearing coupling device 30 with such as ribs or key connections 33, for allowing the shank 17 to be moved up and down relative to the gear 31, and to be rotated or driven by the gear 31.

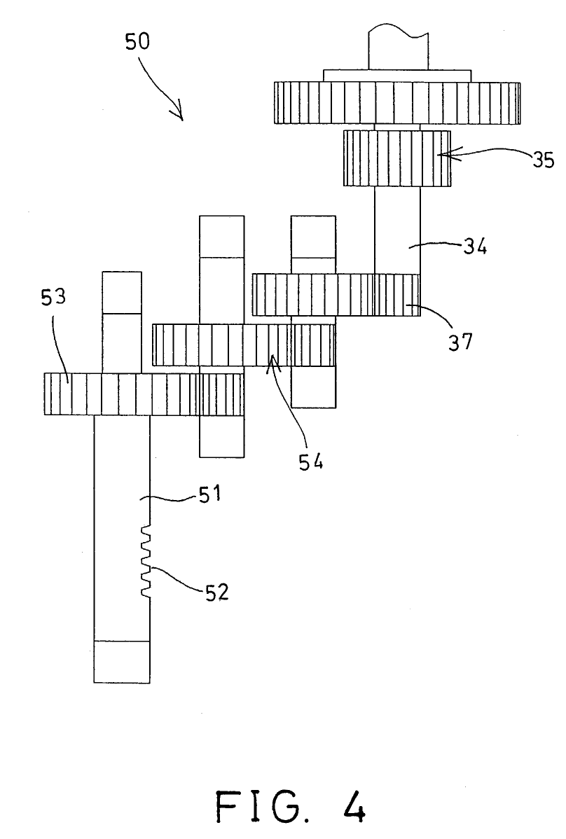

The gearing coupling device 30 includes a rod 34 rotatably supported in the housing 10 and coupled to the gear 31 with a connecting device 35, such as a gearing mechanism 35, and having a pinion 37 provided thereon (FIG. 4). A gear or worm 20 is also rotatably supported in the housing 10 and engaged with the rack 151 of the barrel 15, and includes a gear 21 secured thereto and rotated in concert with each other.

Another reduction gearing or transmission or coupling device 50, such as typical pulley-and-belt coupling device (not shown), typical sprocket-and-chain coupling device (not shown), or gearing coupling device 50 as shown in FIGS. 2-4, is provided for coupling the motor 40 or the rod 34 of the gearing coupling device 30 to the barrel 15, for allowing the barrel 15 to be moved up and down relative to the conduit 13 by the motor 40.

For example, the gearing coupling device 50 includes a pole 51 rotatably supported in the housing 10 and having a number of teeth or a rack or a worm member 52 provided on the outer peripheral portion thereof, and engageable with the gear 21 of the worm 20, and includes a gear 53 attached or secured on the pole 51, and coupled to the pinion 37 of the rod 34 with another connecting device 54, such as a gearing mechanism 54, such that the barrel 15 may be moved up and down relative to the conduit 13 by the motor 40, via the worm 20 and the gearing coupling device 50 and/or the gearing coupling device 30.

In operation, the barrel 15 and the shank 17 and thus the tool member 90 may be moved up and down relative to the conduit 13 and may be engaged onto the work pieces or other objects to be drilled with holes therein by the motor 40. In addition, and simultaneously, the shank 17 may also be rotated or driven by the same or single motor 40, in order to drill holes in the work pieces or other objects. The rotational speed of the shank 17 and the moving or feeding speed of the barrel 15 may be controlled or determined by the coupling devices 30, 50.

The drilling device may thus includes a single motor 40 to rotate the shank 17 and to move or feed the barrel 15, such that the drilling device may include a greatly reduced volume or weight, that is excellent for allowing the drilling device to be moved or carried with the users.

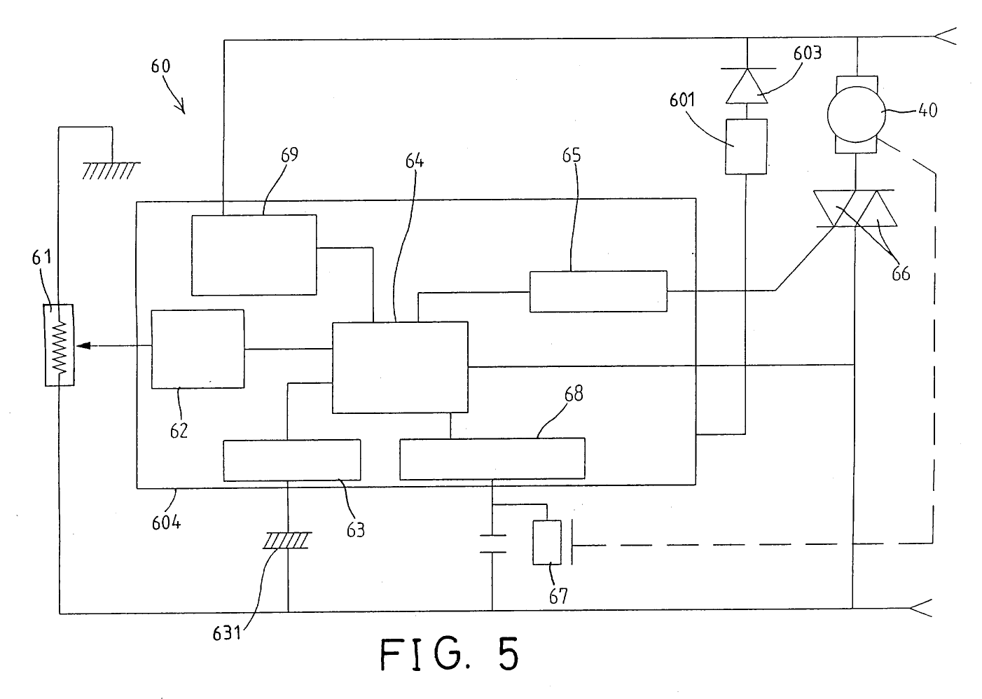

As shown in FIG. 5, the drilling device further includes a control circuit 60 for controlling or driving the motor 40. The control circuit 60 includes a switch member 66, such as a TRIAC 66 coupled to the motor 40 for controlling or switching on and off the motor 40. A phase generator 64 is coupled to the switch member 66 via a phase output circuit 65, in order to generate driving signals to drive the motor 40.

An adjusting device 61, such as a rheostat 61 is coupled to the phase generator 64 via a speed control circuit 62, in order to control the phase generator 64 to adjust the motor 40 to different driving speeds. The adjusting device 61 or the rheostat 61 may be controlled or adjusted by the users with switch buttons (not shown), for allowing the users to adjust the rotating or driving speeds of the motor 40.

A starting circuit 63 and one or more capacitors 631 may be coupled to the phase generator 64, in order to gradually change and supply the capacities or the electric energy of the capacitors 631 to the phase generator 64, in order to gradually increase the driving energy supplied to the motor 40, and so as to gradually increase the rotating or driving speeds of the motor 40, and thus to increase the working life of the motor 40.

A speed detector or a speedometer 67 is coupled to the motor 40 in order to detect the rotating or driving speeds of the motor 40. A frequency/voltage converting circuit 68 is coupled between the speedometer 67 and the phase generator 64, in order to convert the signals of the rotating or driving speeds of the motor 40 from the speedometer 67 into frequency signals, and then to convert the frequency signals into voltage signals.

A voltage compensating circuit 69 may further be provided and coupled between the motor 40 and the phase generator 64, in order to compensate the voltage or the electric energy supplied to the motor 40. For example, the voltage signals from the frequency/voltage converting circuit 68 may be compared with voltage in the speed control circuit 62, in order to determine whether the voltage compensating circuit 69 is required to compensate the voltage or the electric energy supplied to the motor 40 or not, so as to maintain the motor 40 at constant or required or predetermined driving or rotating speeds.

As also shown in FIG. 5, a resistor device 601 and/or a diode 603 may further be provided and coupled together in series, and/or coupled to the motor 40 and the switch member 66 in parallel, and/or coupled in parallel to a circuit assembly 604 including such as the speed control circuit 62 and/or the starting circuit 63 and/or the phase generator 64 and/or the phase output circuit 65 and/or the frequency/voltage converting circuit 68 and/or the voltage compensating circuit 69, for safety purposes.

Accordingly, the drilling device in accordance with the present invention includes a single motor for simultaneously driving or moving and rotating the drilling tool members.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A drilling device comprising:
a housing including a conduit,
a barrel slid ably received in said conduit of said housing, and movable up and down relative to said conduit of said housing,
a shank rotatably secured in said barrel and movable up and down relative to said conduit of said housing in concert with said barrel,
a motor disposed in said housing, and
means for coupling said motor to rotate said shank and to move said barrel up and down relative to said conduit of said housing simultaneously, to allow said barrel and said shank to be actuated simultaneously by said motor.

2. The drilling device as claimed in claim 1, wherein said motor includes a spindle, and said coupling means includes a first coupling device coupled between said shank and said spindle, to allow said shank to be rotated by said motor.

3. The drilling device as claimed in claim 2, wherein said first coupling device includes a gear coupled to said shank with a key connection, to allow said shank to be moved up and down relative to said gear and to be rotated by said gear.

4. The drilling device as claimed in claim 2, wherein said coupling means includes a second coupling device coupled between said first coupling device and said barrel, to allow said barrel to be moved up and down relative to said conduit of said housing by said motor.

5. The drilling device as claimed in claim 4, wherein said barrel includes a rack provided thereon, said second coupling device includes a worm engaged with said rack of said barrel, to move said barrel up and down relative to said conduit of said housing when rotating said worm.

6. The drilling device as claimed in claim 5, wherein said first coupling device includes a rod, a first connecting device coupled between said rod and said motor, said second coupling device includes a gear secured to said worm, a pole having a worm member engaged with said gear of said worm, and a second connecting device coupled between said pole and said rod.

7. The drilling device as claimed in claim 1, wherein said housing includes a positioning device attached thereto, to secure said housing onto objects.

8. The drilling device as claimed in claim 7, wherein said positioning device is an electromagnetic member.

9. The drilling device as claimed in claim 1, wherein said barrel includes a rack provided thereon, said coupling means includes a worm engaged with said rack of said barrel, to move said barrel up and down relative to said conduit of said housing when rotating said worm.

10. The drilling device as claimed in claim 1 further comprising a control circuit coupled to said motor, and to control said motor.

11. The drilling device as claimed in claim 10, wherein said control circuit includes a switch member coupled to said motor, in order to switch and control said motor.

12. The drilling device as claimed in claim 10, wherein said control circuit includes an adjusting device to adjust said motor to different rotational speeds.

13. The drilling device as claimed in claim 10, wherein said control circuit includes a starting circuit coupled to said motor to gradually increase a rotational speed of said motor.

14. The drilling device as claimed in claim 10, wherein said control circuit includes a compensating circuit coupled to said motor, to compensate an electric energy supplied to said motor.
